(19) United States
(12) Patent Application Publication
(10) Pub. No.: US 2025/0294602 A1
(43) Pub. Date: Sep. 18, 2025

(54) SPECTRUM SHAPING VIA CODING SCHEMES TO ADDRESS EMISSION CONSTRAINTS

(71) Applicants: AT&T Intellectual Property I, L.P., Atlanta, GA (US); University of Notre Dame du Lac, South Bend, IN (US)

(72) Inventors: Ralf Bendlin, Cedar Park, TX (US); Xiangbo Meng, South Bend, IN (US); Bertrand Martyn Hochwald, South Bend, IN (US); Jonathan David Chisum, South Bend, IN (US); J. Nicholas Laneman, Granger, IN (US)

(73) Assignees: AT&T Intellectual Property I, L.P., Atlanta, GA (US); University of Notre Dame du Lac, South Bend, IN (US)

(21) Appl. No.: 18/605,280

(22) Filed: Mar. 14, 2024

(51) Int. Cl. H04W 72/541; H04L 5/00; H04W 72/0453

(52) U.S. Cl. CPC H04W 72/541; H04L 5/006; H04L 5/0064; H04W 72/0453

(57) ABSTRACT

Aspects of the subject disclosure may include, for example, determining a channel condition of a communication channel and identifying a bandwidth-related power constraint imposed upon the communication channel. A spectrum encoding strategy is determined based on the channel condition and the bandwidth-related power constraint, wherein application of the spectrum encoding strategy facilitates compliance with the bandwidth-related power constraint. The spectrum encoding strategy may be provided to a receiver to facilitate reliable communication of digital information over the communication channel according to the bandwidth-related power constraint. Other embodiments are disclosed.

### FIELD OF THE DISCLOSURE

Spectrum shaping via coding schemes to address emission constraints.

### BACKGROUND

Digital communication includes a transmission and reception of data in the form of a digital bitstream or a digitized analog signal over a point-to-point or point-to-multipoint communication channel. A digital communication transmitter receives information in a form of data, e.g., bits and/or a bit stream. The transmitter may apply channel coding to improve error performance, modulation to covert groups of bits into symbols and digital to analog conversion (DAC) to generate a corresponding analog waveform that may be applied to a radio frequency (RF) front end for analog processing, e.g., frequency translation, filtering and/or amplification.

Transmitted signals are generally allocated a limited bandwidth, referred to as a channel. A transport media may support many such channels according to a spectrum management plan that may allocate bandwidth to channels and often some guard band between channels to reduce inter-channel interference. Frequency management plans may identify and/or otherwise specify tolerable limits to unwanted spectral emissions, such as out-of-band (OOB) emissions occurring outside of a channel bandwidth. In some instances, a spectral mask may identify one or more attenuation levels and/or maximum emission levels for OOB emissions. Alternatively, or in addition, a percentage of maximum acceptable OOB emissions to a total emission level may be specified as a single number, e.g., 1% indicating that no more than 1% of the signal power may exist outside of an allocated or occupied channel bandwidth.

The underlying information transmitted by a digital communication system relates to bits and/or symbols represented by pulses of energy. Accordingly, the transitions between transmitted bits and/or symbols may be abrupt, e.g., in the form of square waves or pulses, which may lead to spectral broadening, or a spreading of signal energy outside of an allocated bandwidth or channel. Traditionally, digital pulse-shaping filters, such as raised cosine filters, are used for avoiding unwanted OOB emissions. In such instances, the data pulses forwarded to a digital radio's RF front end are carefully shaped to avoid abrupt transitions. Consequently, high-resolution DACs are required to preserve fidelity of analog representations of the shaped pulses forwarded to the RF front end. Compromises or limits to a resolution of the DAC may introduce quantization errors that would negate benefits of the pulse shaping filter.

These conventional methods that use digital pulse-shaping filters to confine the OOB emissions, may be predetermined between a transmitter and a receiver, with a symbol rate determined by allocated bandwidth and excess bandwidth resulting from the pulse-shaping filter. Accordingly, in such communication systems, a transmitter and a receiver would only need to exchange a modulation and coding scheme, e.g., identification of an applied modulation and a corresponding channel code rate.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communications network adapted for managing OOB emissions through spectral coding with low-resolution DACs in accordance with various aspects described herein.

FIG. 2A is a block diagram illustrating a prior art digital communication system adapted for managing OOB emissions through pulse shape filtering.

FIG. 2B is a block diagram illustrating an example, non-limiting embodiment of a digital communication system adapted for managing OOB emissions through spectral coding and with low-resolution DACs, functioning within the communication network of FIG. 1 in accordance with various aspects described herein.

FIG. 2C is a block diagram illustrating an example, non-limiting embodiment of a spectrum encoder operating within a digital communication system adapted for managing OOB emissions through spectral coding and with low-resolution DACs, functioning within the communication network of FIG. 1 in accordance with various aspects described herein.

FIG. 2D is a block diagram illustrating an example, non-limiting embodiment of another spectrum encoder operating within a digital communication system adapted for managing OOB emissions through spectral coding and with low-resolution DACs, functioning within the communication network of FIG. 1 in accordance with various aspects described herein.

FIG. 2E is a block diagram illustrating an example, non-limiting embodiment of a digital communication transmitter adapted for managing OOB emissions through spectral coding and with low-resolution DACs, functioning within the communication network of FIG. 1 in accordance with various aspects described herein.

FIG. 2F is a block diagram illustrating an example, non-limiting embodiment of a digital communication system adapted for managing OOB emissions through spectral coding and with low-resolution DACs, functioning within the communication network of FIG. 1 in accordance with various aspects described herein.

FIG. 2G is a block diagram illustrating an example, non-limiting embodiment of an example operation of a digital communication system adapted for managing OOB emissions through spectral coding and with low-resolution DACs, functioning within the communication network of FIG. 1 in accordance with various aspects described herein.

FIG. 2H depicts an illustrative embodiment of a digital communication process adapted for managing OOB emissions through spectral coding and with low-resolution DACs, in accordance with various aspects described herein.

FIG. 3 is a block diagram illustrating an example, non-limiting embodiment of a virtualized communication network adapted for managing OOB emissions through spectral coding with low-resolution DACs in accordance with various aspects described herein.

FIG. 4 is a block diagram of an example, non-limiting embodiment of a computing environment adapted for managing OOB emissions through spectral coding with low-resolution DACs in accordance with various aspects described herein.

FIG. 5 is a block diagram of an example, non-limiting embodiment of a mobile network platform adapted for managing OOB emissions through spectral coding with low-resolution DACs in accordance with various aspects described herein.

FIG. 6 is a block diagram of an example, non-limiting embodiment of a communication device adapted for managing OOB emissions through spectral coding with low-resolution DACs in accordance with various aspects described herein.

### DETAILED DESCRIPTION

The subject disclosure describes, among other things, illustrative embodiments for an application of spectrum coding within a digital communication system to confine OOB emissions to within some predetermined level. Other embodiments are described in the subject disclosure.

One or more aspects of the subject disclosure include a process for determining a coding strategy to promote confinement of a power spectral density within an allocated bandwidth. The process includes determining, by a processing system including a processor, channel condition of a communication channel and identifying, by the processing system, a bandwidth-related power constraint imposed upon the communication channel to limit and/or otherwise control or shape out-of-band emissions. A spectrum encoding strategy is determined, by the processing system, based on the channel condition and the bandwidth-related power constraint, wherein application of the spectrum encoding strategy to digital information to obtain encoded data facilitates compliance of a transmission of the encoded data with the bandwidth-related power constraint. According to the process, the spectrum encoding strategy is transmitted, by the processing system, to a receiver to facilitate reliable communication of the digital information over the communication channel according to the bandwidth-related power constraint.

One or more aspects of the subject disclosure include a device including a processing system including a processor and a memory that stores executable instructions. The instructions, when executed by the processing system, facilitate performance of operations that include receiving an indication of a channel condition of a communication channel and identifying a bandwidth-related power constraint imposed upon the communication channel. A spectrum encoding strategy is determined based on the channel condition and the bandwidth-related power constraint, wherein application of the spectrum encoding strategy to digital information to obtain encoded data facilitates compliance with the bandwidth-related power constraint. The spectrum encoding strategy is provided to a receiver to facilitate reliable communication of the digital information over the communication channel according to the bandwidth-related power constraint.

One or more aspects of the subject disclosure include a non-transitory machine-readable medium, including executable instructions that, when executed by a processing system including a processor, facilitate performance of operations. The operations include determining channel condition of a communication channel and identifying a bandwidth-related power constraint imposed upon the communication channel. A spectrum encoding strategy is determined based on the channel condition and the bandwidth-related power constraint, wherein application of the spectrum encoding strategy to digital information to obtain encoded data facilitates compliance of a transmission of the encoded data with the bandwidth-related power constraint. Configuration of receiver according to the spectrum encoding strategy facilitates reliable communication of digital information over the communication channel according to the bandwidth-related power constraint.

Disclosed herein are novel techniques including a process, an apparatus and machine-readable media, for determining a modulation and coding scheme, and in at least some instances a symbol rate, based on one or more of a channel condition, a quantization resolution, and bandwidth-related power constraint, e.g., an out-of-band power constraint. Without limitation, the out-of-band power constraint may impose absolute and/or relative power limitations on spectral emissions, such as out-of-band emissions that extend beyond an operational, allocated and/or authorized bandwidth or channel. At least some applications include low-resolution digital communication systems in which a digital pulse-shaping filter may not be available. The novel techniques identify and/or apply a spectrum coding to confine spectral emissions of a transmitted signal to ensure compliance with OOB requirements. In use, a symbol rate, a specific spectrum code and the corresponding code rate may be identified and shared between a communicating transmitter-receiver pair, such that the communication devices may be suitably configured to implement the spectrum encoding to reliably transfer digital information, while also satisfying applicable OOB constraints.

A typical wireless mobile communication system may select a modulation and coding scheme purely based on a channel condition, assuming a digital pulse-shaping filter can satisfy an out-of-band power constraint. However, such pulse-shaping filters are neither necessary nor available when the transmitter has limited resolutions. The examples provided herein include a one-bit BPSK transmitter, which may be generalized to other resolutions and/or modulations. In at least some embodiments, the example processing includes at least two parameters: a symbol rate and an MCS level, which may be adjustable. These values may be determined in such a manner so as to meet a target spectral efficiency (SE) under given channel condition, e.g., SNR, and/or OOB constraint.

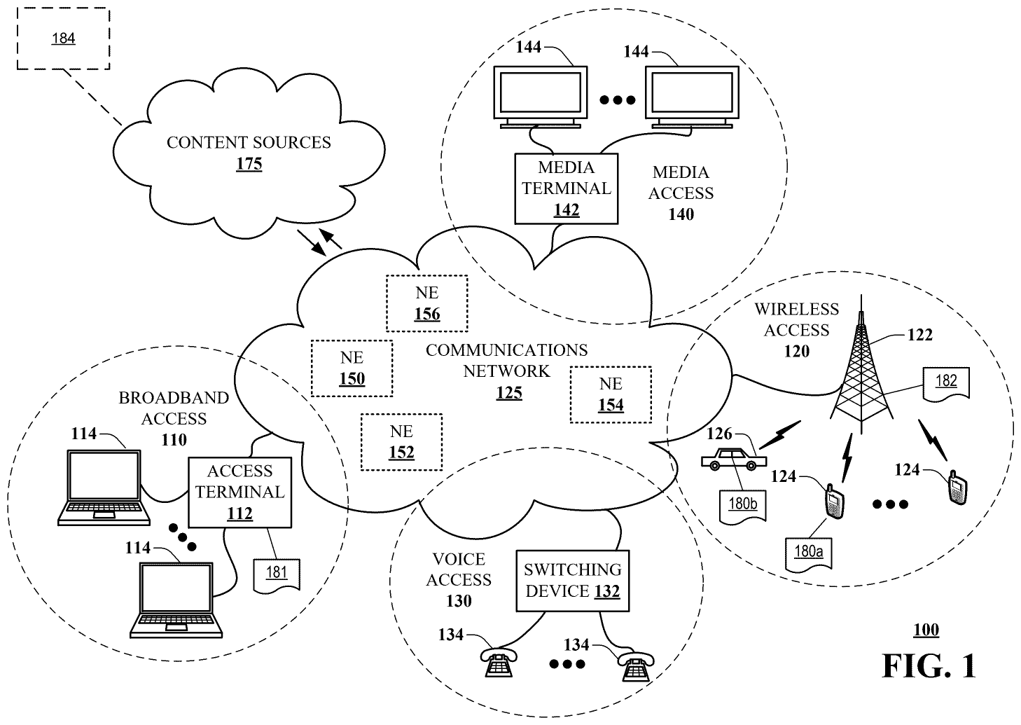

Referring now to FIG. 1 a block diagram is shown, illustrating an example, non-limiting embodiment of a communications network 100 adapted for managing OOB emissions through spectral coding with low-resolution DACs in accordance with various aspects described herein. For example, system 100 can facilitate in whole or in part determination of a channel condition of a communication channel and identification of a bandwidth-related power constraint imposed upon the communication channel. A spectrum encoding strategy may be determined based on the channel condition and the bandwidth-related power constraint, wherein an application of the spectrum encoding strategy facilitates compliance with the bandwidth-related power constraint. The spectrum encoding strategy may be provided to a receiver to facilitate reliable communication of digital information over the communication channel according to the bandwidth-related power constraint. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

It is envisioned that in at least some of these links and/or network elements 150, 152, 154, 156 of the communications network 125 may be configured to apply spectrum encoding techniques, such as any of the various examples provide herein, to address OOB emissions at least in part, based on an application of spectrum coding, such as the example polar encoding techniques discussed herein. In at least some embodiments the spectrum codes may be identified and/or otherwise selected for application based on an OOB specified value, such as maximum percentage of tolerable OOB emissions.

For example, digital transmitters in mobile devices, such as the mobile devices 124 and/or vehicle 126 may include a digital communication systems 180, 180b configured to identify a channel condition and an OOB requirement, to select a modulation and/or encoding scheme that applies a spectrum code, such as a polar code to satisfy, at least in part, the OOB requirements. It is envisioned that similar techniques may be applied to digital transmitters 181 of other systems, such as the example broadband access networks 110 to control OOB emissions to avoid inter channel interference.

In at least some embodiments, the digital transmitters 180a, 180b, 181 may be adapted to identify suitable modulation and coding schemes based on channel conditions and OOB emission requirements. Alternatively, or in addition, a remote processor 184 may be configured to identify channel conditions and applicable OOB emission requirements, and to select a suitable digital radio configuration, e.g., an MCS including spectrum coding which may be identified and/or otherwise selected according to one or more performance requirements, such as the OOB emission requirements, adapted to satisfy the OOB conditions in view of the channel conditions. Such MCS solutions may be provided by the processor 184 to the corresponding digital radios 180a, 180b, 181, which may be configured to reconfigure based on the received MCS configuration. It is understood that, in at least some embodiments, the MCS may be applied in addition and subsequent to channel coding.

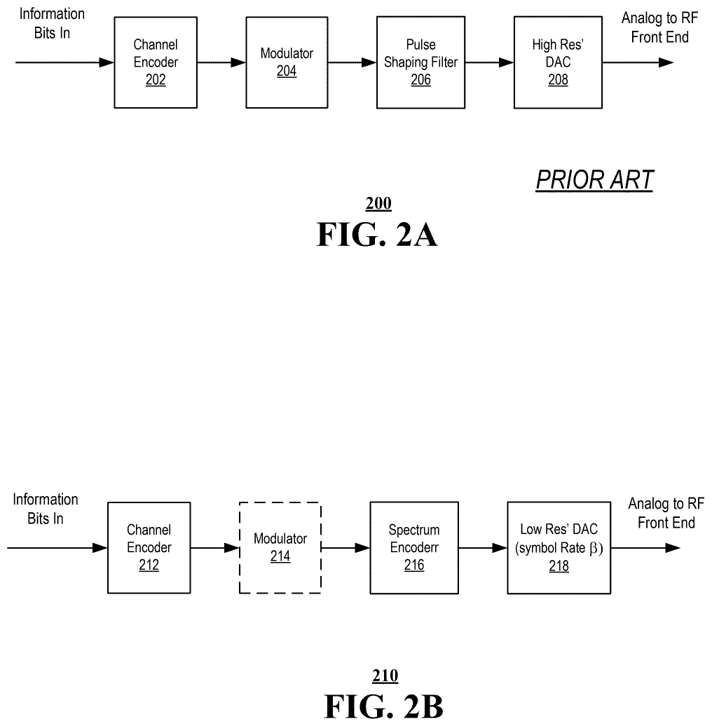

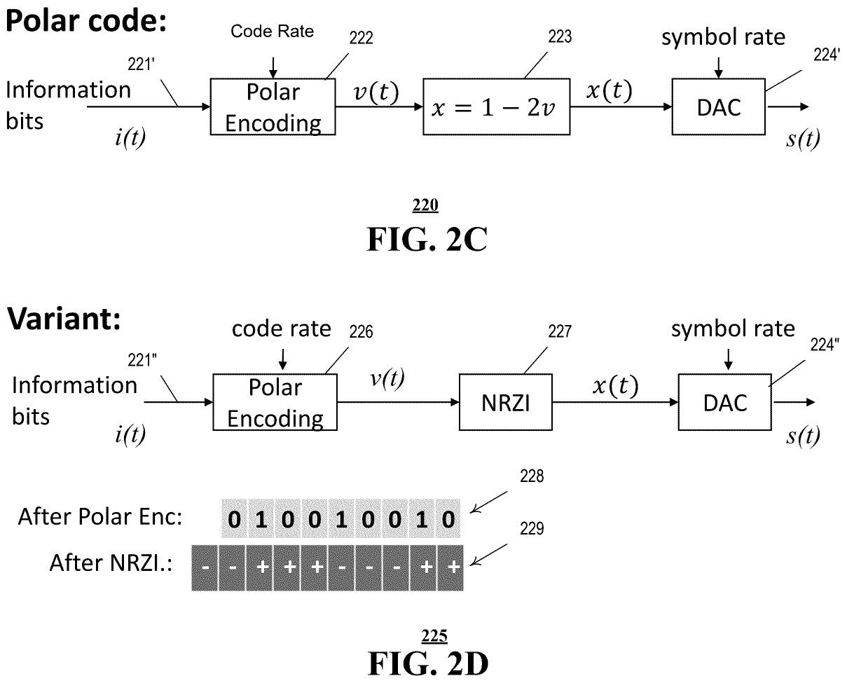

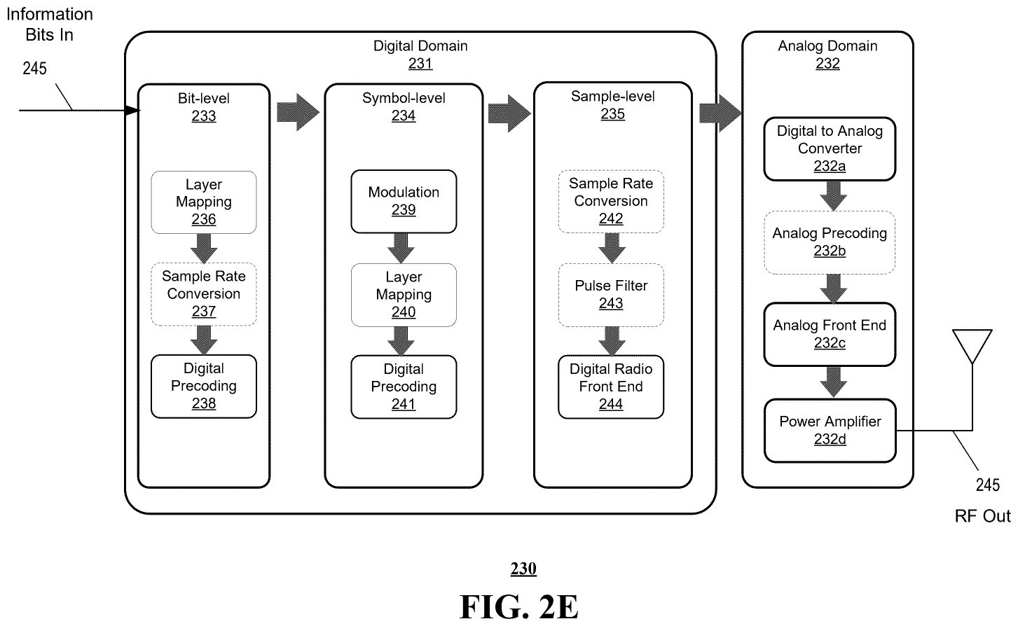

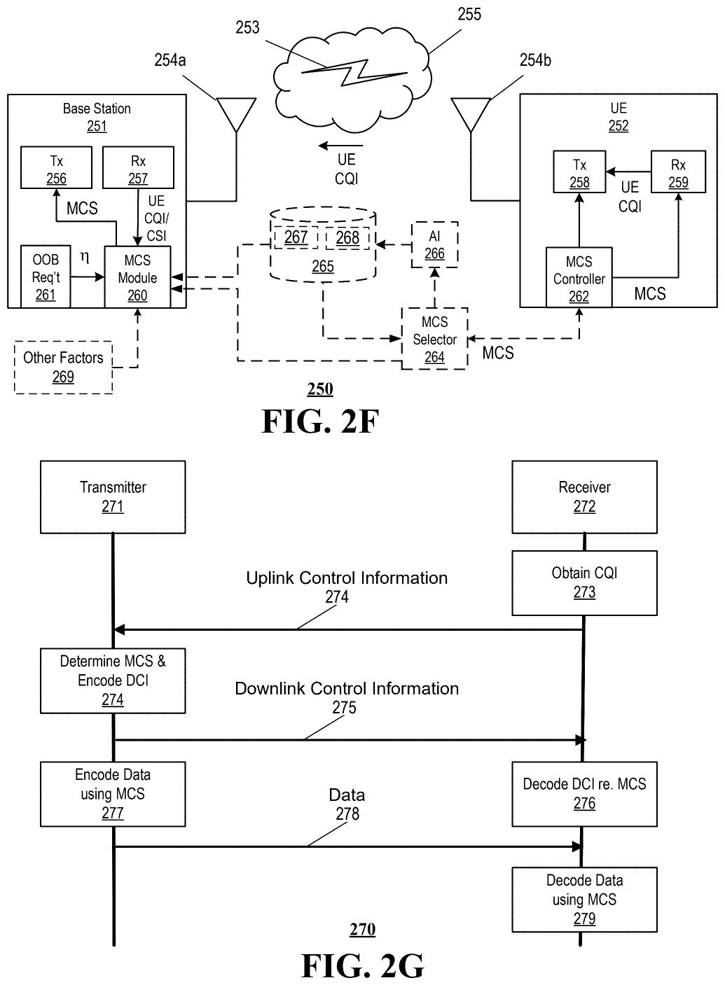

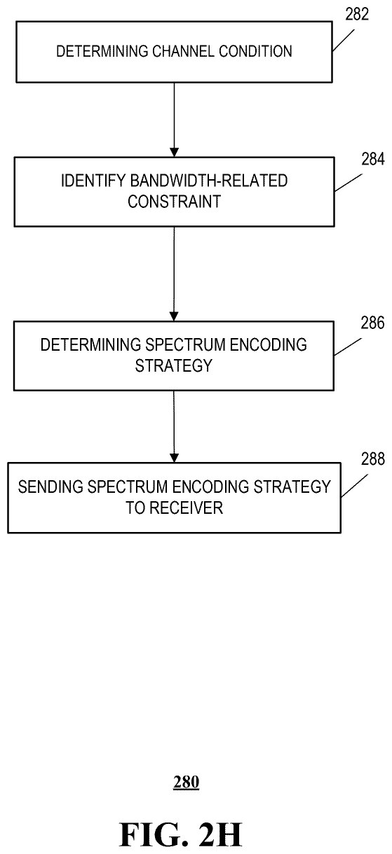

FIG. 2A is a block diagram illustrating a prior art digital communication system 200 adapted for managing OOB emissions by application of pulse shape filtering. The example prior art digital communication system 200 may include digital pulse shaping alone or in combination with other measures to control unwanted out-of-band emissions in single carrier communications. The example digital communication system 200 includes a channel encoder 202, a modulator 204, a pulse shaping filter 206 and a relatively high-resolution DAC 208. The channel encoder 202 may employ error correction by adding parity bits to information bits according to an error correction scheme. Any of a number of well-known error correction techniques may be utilized, such as linear block coding and/or convolutional coding. A ratio of the data bits to the resulting encoded bits may be referred to as a code rate.

The modulator may map a group of bits, e.g., channel bits when channel encoding has been applied, to a symbol. The modulation may be applied according to any one of a variety of different modulation techniques. Depending upon the type of modulation, information bearing symbols may be distinguished according to adjustments of one or more of an amplitude, a phase or a frequency. The symbols may be produced by the modulator 204 and/or otherwise forwarded toward the DAC 208 at a rate referred to as the symbol rate.

Transitions between bits and/or pulses may be represented by square waves, with abrupt transitions occurring between at least some adjacent bits and/or symbols. Without further processing, such abrupt transitions may result in excessive amounts of unwanted energy extending beyond an occupied bandwidth, which may otherwise lead to a violation of applicable OOB requirements. The example digital communication system 200 includes a pulse shaping filter 206, e.g., applying a raised cosine filter to the pulse samples, which results in a softening of the otherwise square-wave transitions and yielding a containment of OOB emissions. A resulting shaped symbol or sample pulse is provided to a relatively high-resolution DAC 208, providing sufficient quantization to faithfully reproduce the shaped symbol pulse, which may then be provided to an analog front end for further processing and transmission. The preserved pulse shape in the analog signal may ensure that the OOB emissions are constrained to within a predetermined and/or otherwise specified requirement.

In operation, the digital communication system 200 receives an input consisting of data, e.g., information bits and provides a modulated, encoded and suitably filtered or shaped signal to a transmitter front end (not shown) for one or more of frequency translation, e.g., up-conversion, signal conditioning, e.g., additional filtering, attenuation and/or amplification, and transmission over a physical medium. Without limitation, physical media, as referred to herein, may include over-the-air or free space, e.g., via RF, microwave, millimeter wave, terahertz, infra-red, optical, channels. Alternatively, or in addition, physical media may include an optical fiber, a coaxial cable, twisted copper pair, a wire.

FIG. 2B is a block diagram illustrating an example, non-limiting embodiment of a digital communication system 210 adapted for managing OOB emissions through spectral coding without requiring relatively high-resolution DACs, e.g., with low-resolution DACs, functioning within the communication network 100 of FIG. 1, in accordance with various aspects described herein. In at least some embodiments, the digital communication system 210 includes a channel encoder 212, a spectrum encoder 216 and a relatively low-resolution DAC 218. Once again, the channel encoder 212 may employ error correction by adding parity bits to the data bits. In at least some embodiments, the digital communication system 210 includes a modulator 214 (shown in phantom). The modulator 214, when provided, may map a group of information bits to a symbol according to any one of a variety of modulation techniques. The encoded bits or symbols when the digital communication system 210 includes the modulator 214 are forwarded toward the DAC 208 at a rate referred to as the bit or symbol rate. In at least some embodiments, the modulator 214 and the spectrum encoder 216 may be combined, such that spectrum encoding includes modulation, e.g., to facilitate a joint optimization. However, in at least some embodiments, the modulator 214 may be positioned after the spectrum encoder 216, such that spectrum-encoded bits are modulated according to a process. The process may include a transformation, such as a linear transformation, that may apply an offset and/or scaling to the spectrum-encoded bits. Alternatively, or in addition, the modulation process may include application of a non-return-to-zero inverted (NRZI) transformation. Both examples discussed further hereinbelow in reference to FIGS. 2C-2D.

According to the novel techniques disclosed herein, the digital communication system 210 also includes a spectrum encoder 216 that may be configured to apply at least one of a variety of codes adapted to reduce OOB emissions, preferably to within some predetermined and/or otherwise specified value. The spectrum-encoded bits are provided to the relatively low-resolution DAC 218 for conversion to analog and forwarding to an analog front end. In at least some embodiments, the spectrum-encoded bits or symbols are provided to the low-resolution DAC 218 with little or even no pulse shaping. Accordingly, the encoded symbols may be submitted directly to the low-resolution DAC 218, which may be configured to operate at a resolution sufficient to reproduce analog signal corresponding to the bits or symbols. In a limiting case, the low-resolution DAC 218 is a single-bit DAC, configured to produce an analog signal based on the encoded bits or symbols, without the use of a pulse shaping filter 206 (FIG. 2A).

For example, the digital communication system 210 may operate according to an on-off-keying (OOK) configuration. The OOK configuration may not require a modulator 214, such that the encoded information bits obtained from the channel encoder 212 may be further encoded by the spectrum encoder 216, then provided to the low-resolution DAC 218. In at least some embodiments, the low-resolution DAC 218 may operate according to a 1-bit DAC configuration, which may be sufficient, providing substantially square pulse signals to the analog front end. Beneficially, the spectrum encoding employed by the spectrum encoder 216 may be selected and applied to suitably shape a resulting signal spectrum of a transmitted passband signal to satisfy an OOB requirement.

FIG. 2C is a block diagram illustrating an example, non-limiting embodiment of a spectrum shaping encoder 220 operating within a digital communication system adapted for managing OOB emissions through spectral coding and with low-resolution DACs, functioning within the communication network 100 of FIG. 1 in accordance with various aspects described herein. The example spectrum shaping encoder 220 includes the spectrum encoder module 222 and a low-resolution DAC 224′. The spectrum encoder module 222 receives information bits 221′, e.g., in the form of an information signal, i(t), applies a spectrum shaping code to the information bits to produce spectrum encoded bits that are forwarded, e.g., in the form of a spectrum encoded signal, v(t), to the low-resolution DAC 224′.

It is understood that in at least some embodiments the information bits may include channel encoded information bits, e.g., having been encoded according to a forward error correcting code. The forward error correcting code generally introduces some number of parity bits resulting in a first code rate, r₁, as a measure of the information carrying bits to the encoded bits including the parity bits. Likewise, the spectrum encoder module 222 may include additional non-information bits that facilitate spectrum containment in a resulting transmit spectrum resulting in a second code rate, r₂, as a measure of the information carrying bits to the encoded bits including the additional non information bits.

According to the illustrative example the spectrum encoder module 222 functions according to a code rate that may be provided as a selectable and/or otherwise changeable input value, producing spectrum encoded bits or symbols according to the selected code rate. In at least some embodiments, the spectrum encoder module 222 applies a spectrum shaping code adapted to decrease the frequency of transitions within a spectrum encoded signal, possibly with little or no reliance upon a pulse shaping filter. For example, at least some spectrum shaping codes may introduce extended sequences of like-kind bits, effectively widening pulses in a square wave spectrum encoded output signal, v(t).

It is understood that spectrum shaping codes may be referred to as modulation codes, or line codes, or data translation codes. Such spectrum shaping codes generally place restrictions on a sequence of bits, such as those bits directed into a modulator, and thus introduce correlation and hence memory into the transmitted signal. By way of non-limiting example one such class of spectrum shaping codes is referred to as polar codes. The spectrum encoder module 222 implementing a polar code receives an input signal, i(t), which may include information bits, e.g., 0's and 1's, or channel bits when error correction has been applied. The spectrum encoder module 222, by way of the polar code, may introduce additional spectrum shaping bits in such a manner so as to produce relatively long sequences or strings of 0's or 1's in a resulting spectrum encoded output signal representing the spectrum encoded bits at the code rate. The DAC 224′ performs a digital-to-analog conversion of the spectrum encoded signal, v(t).

Beneficially, the spectrum encoded signal is capable of reducing OOB of an information signal according to the spectrum encoding and without necessarily including a pulse shaping filter. Accordingly, and in at least some embodiments, the DAC 224′ may perform a digital-to-analog conversion of the resulting square wave of spectrum encoded signal, v(t), without requiring a pulse shaping filter. Consequently, the DAC 224′ may operate according to a low-resolution or low fidelity and in least some embodiments, as a 1-bit DAC. It is envisioned that in at least some embodiments, a pulse shaping filter (not shown here) may be employed before the DAC 224′. It is understood, however, that with a combination of spectrum encoding, e.g., with the example spectrum encoding module 222 applying a polar code, satisfactory control of OOB emissions may be obtained with a lower resolution DAC 224′ than would otherwise be required without the spectrum encoding module 222 applying a polar code. The low-resolution DAC 224′ may be operated according to a bit or symbol rate. Without limitation, a low-resolution DAC 224′ may include a single-bit resolution DAC, a two-bit resolution DAC, or a DAC having a few bits or more, but generally less than would otherwise be necessary for traditional applications using pulse shaping filters.

It may be appreciated that an ability to control OOB emissions with a lower resolution DAC 224′ than would otherwise be required without the spectrum encoding module 222 reduces a complexity within the digital transmitter. Such reductions in complexity realize cost savings and/or other benefits such as reduced size and/or power consumption. It is envisioned that such low-resolution transmitters capable of controlling OOB emissions may be more widely adopted. At least some applications include, without limitation, broadband systems and/or wide-band communication systems such as MIMO systems including massively MIMO systems in which large numbers of similar transmitter circuits may be required to operate within a limited space and/or power requirement. Other applications may include machine type communication systems, e.g., according to the Internet of Things (IoT).

In at least some embodiments, the spectrum shaping encoder 220 may perform one or more transformations to the spectrum encoded bits or signal, v(t). For example, the spectrum shaping encoder 220 may include a transformer module 223 positioned between the spectrum shaping encoding module 222 and the low-resolution DAC 224′. The transformer module 223 may be configured to receive spectrum encoded bits or signal, v(t), from the spectrum encoding module 222, and to apply at least one transformation to the input resulting in transformed spectrum encoded bits or signal, x(t), which may be directed toward the low-resolution DAC 224′.

According to the illustrative example, and without limitation, the transformer module 223 is configured to perform a linear transformation. In this particular example, the linear transformation would operate to offset an input signal, v(t), with input signal values extending between “0” and “1,” to a transformed signal, x(t), with transformed signal values extending between “−1” and “1.” Such a transformation may be applied to transform a unipolar signal to a bipolar signal, e.g., as in BPSK.

FIG. 2D is a block diagram illustrating an example, non-limiting embodiment of another spectrum shaping encoder 225 operating within a digital communication system adapted for managing OOB emissions through spectral coding and with low-resolution DACs, functioning within the communication network 100 of FIG. 1 in accordance with various aspects described herein. The spectrum shaping encoder 225 is a variant of the preceding example in which incorporates a different type of transformer module 227. As in the preceding example, the spectrum shaping encoder 225 includes a spectrum shaping module 226, a transformer module 227 and a low-resolution DAC 224″. The example spectrum shaping module 226 is configured to apply a polar encoding scheme. The spectrum shaping module 226 receives information bits 221″ or an information signal, i(t), and applies the polar code to obtain a polar encoded bits or signal, v(t). The polar encoding may be applied according to a corresponding encoded rate that may be a selectable rate. The transformer module to 227 may be configured to apply a transformation to the polar encoded bits or signal, v(t), to obtain transformed polar encoded bits or a transformed polar encoded signal, x(t), which may be provided as an input to the low-resolution DAC 224″. The low-resolution DAC 224″ performs a digital to analog conversion upon the transformed polar encoded bits or signal, x(t) to obtain a corresponding analog signal s(t), which may be provided to a front end of a transmitter for further analog processing.

By way of example, and without limitation, the transformation applied by the transformer module 227 is referred to as a non-return-to-zero inverted (NRZI) transformation. A non-return-to-zero (NRZ) code is a binary code in which “1's” are represented by one significant condition, usually a positive voltage, while “0's” are represented by some other significant condition, usually a negative voltage, with no other neutral or rest condition. The NRZI variant is also a binary encoding method in which changes between two significant condition, e.g., positive and negative voltages, represent “1's,” while no changes represent “0's.”

Also illustrated is an example of a string of polar encoded bits, e.g., a polar code word 228, which includes the values “010010010.” A corresponding NRZI transformed line code 229 is illustrated below the polar code word 228. According to the illustrative example the transformed line code 229 is initially in a “negative” state. In reaction to the first “0” of the polar code word 228, the NRZI transformed line code 229 remains unchanged, i.e., “negative.” However, in reaction to the first “1” of the polar code word 228, the NRZI transformed line code 229 transforms from its then current state, i.e., “negative,” to an alternate state, i.e., “positive.” The NRZI transformation continues in a like manner, responding to “1's” with state changes and to “0's” with no state changes.

FIG. 2E is a block diagram illustrating an example, non-limiting embodiment of a digital communication transmitter 230 adapted for managing OOB emissions through spectral coding and with low-resolution DACs, functioning within the communication network 100 of FIG. 1 in accordance with various aspects described herein. The example digital communication transmitter 230 includes functionality that may be generally distinguished between two different domains. The first domain may be referred to as a digital domain 231, which may be configured to receive input information in the form of data, e.g., input information bits 245. The digital domain 231 may be configured to process the input information bits 245 in preparation for forwarding to an analog domain 232 of the digital communication transmitter 230.

In more detail, the digital domain 231 includes a bit-level segment 233 that may be configured to receive the information bits 245 and to perform bit-level processing thereupon to obtain bit-level processed bits. By way of non-limiting example, the bit-level segment 233 includes a bit-level, digital precoding function 238. In at least some embodiments, the bit-level, digital precoding function 238 may include application of one or more codes such as the example error correction codes and/or the example spectral shaping codes discussed above. It is conceivable that the bit-level segment 233 may include one or more other functions that may be categorized as bit-level processing, such as a layer mapping function 236 that may assign groups of bits to different layers of a multi-layer protocol. Alternatively, or in addition, the bit-level segment 233 may include a sample rate conversion function 237 as may be advantageous in operation of the bit-level processing and or alone or in combination with other functions performed within the digital domain 231 and/or within the analog domain 232.

According to the illustrative embodiment, spectrum-encoded bits prepared within the digital domain 231 may be forwarded to the analog domain 232. The analog domain 232 may be configured to perform one or more analog functions. These functions may include, without limitation, analog conversion, e.g., using a digital to analog converter 232a, analog front-end processing 232c and gain adjustments as may be accomplished by a power amplifier to 232d. Analog front end processing 232c may include, without limitation filtering, e.g., low-pass filtering, high-pass filtering, bandpass filtering, notch filtering, and so on. Other examples of front-end processing 232c may include frequency translation, such as frequency up-conversion configured to translate a signal spectrum of an output of the digital to analog converter 232a to a pass band channel location. Gain adjustments as may be introduced by a power amplifier 232d may include amplification, attenuation, or combinations thereof. An output of the power amplifier 232d may be coupled to a transducer 245. It is understood that such a transducer 245 may be adapted to a particular medium within which the analog signal is transported. For RF wireless applications the transducer 245 may take the form of an antenna and/or an antenna array.

In at least some embodiments, an output of the bit-level segment 233 may be provided to the analog domain 232, without further digital processing such as without modulation, and/or without pulse filtering, and so on. In such instances, the DAC 232a may receive spectrum encoded bits from the bit-level, digital precoding module 238 of the bit-level segment 233. It is understood that in at least some embodiments the DAC 232a may utilize a so-called low-resolution DAC. A low-resolution DAC, such as a 1- or 2-bit DAC would be sufficient as the input to the DAC 232a would approximate a unipolar or bipolar square wave of the spectrum encoded bits.

In at least some embodiments, the digital domain 231 may include one or more of a symbol-level segment 234 and a sample-level segment 235. The symbol-level segment 234 may be configured to receive bit-level processed bits from the bit-level segment 233, perform one or more symbol-level processes and provide a symbol processed output to the sample-level segment 235, if present, or to the analog domain 232 otherwise. Symbol-level processing may include one or more of a modulation function 239, a layer-mapping function 240, and a symbol-level, digital precoding function 241. The modulation function 239 may be configured to map bits received from the bit-level segment 233 to symbols according to a modulation scheme. A layer mapping function 240 may be configured to map groups of symbols to different layers of a multilayer protocol. In at least some embodiments, the symbol-level, digital precoding function 241 may include application of one or more codes such as the example error correction codes and/or the example spectral shaping codes discussed above. It is understood that the spectrum encoding may be applied by the bit-level, digital precoding function 238, the symbol-level, digital precoding function 241, or some combination of both functions 238, 241.

Sample-level processing may include one or more of a sample rate conversion function 242, a pulse filtering function 243, and/or a digital radio front-end function 244. The sample rate conversion function 242 may be configured to change a sample rate from one sample rate to another sample rate, e.g., as may be advantageous to processing within the digital domain 231, e.g., within the sample-level segment 235. Rate conversion may include up conversion, down conversion, or combinations of up and down conversion. A pulse filtering function 243 may be configured to shape a pulse output from the bit-level segment 233 and/or the symbol-level segment 234, as may be advantageous by introducing a first spectrum shaping component attributable to the pulse shape modifications introduced by the pulse filtering function 243 period. In one-bit systems, a modulation step may be performed by a transformation step, such as a linear transformation step and/or an NRZI step. However, for other applications that map two or more bits to each symbol, a spectrum coding may be included within a modulation process to selectively control out-of-band emissions. Such a combination of spectrum encoding with modulation would facilitate joint optimization or determination of the encoding and modulation processes.

In at least some embodiments, the symbol-level, digital precoding function 241 may include application of one or more codes such as the example error correction codes and/or the example spectral shaping codes discussed above. It is understood that the spectrum encoding may be applied by the bit-level, digital precoding function 238, the symbol-level, digital precoding function 241, or some combination of both functions 238, 241.

In some embodiments, a first spectrum shaping component attributable to the pulse filtering function 243 may be sufficient to satisfy out of band emission requirements. In other embodiments, a second spectral shaping component is attributable to the spectrum encoding introduced by the digital precoding function 238 and or the digital precoding function 241 may be sufficient to satisfy out of band emission requirements without the aid of a pulse filtering function 243. In yet other embodiments, combinations of the first and second spectrum shaping components, attributable to both the digital precoding function(s) 238, 241 and the pulse filtering function 243, may cooperatively satisfy out of band emission requirements.

In at least some embodiments, the techniques disclosed herein may be applied to low-resolution devices, such as low-resolution transmitters. It is understood that low-resolution devices may forego at least some of the devices of the example digital communication transmitter 230. For example, a low-resolution transmitter may not require one or more of sample rate conversion 237, 242, layer mapping 236, 240, digital precoding 214, analog precoding 232b and in at least some embodiments, digital-to-analog converter 232a, e.g., according to an on-off-keying (OOK) application, Nevertheless, a spectrum encoding may be applied to reduce and/or otherwise limit out-of-band emissions.

FIG. 2F is a block diagram illustrating an example, non-limiting embodiment of a digital communication system 250 adapted for managing OOB emissions through spectral coding, which may be used with low-resolution DACs, all functioning within the communication network 100 of FIG. 1 in accordance with various aspects described herein. The example digital communication system 250 is directed to a wireless communication system, as may be utilized with LTE, 4G, 5G and beyond applications. The example digital communication system includes a base station 251 and a mobile communication device referred to as user equipment (UE) 252. The base station 251 and the UE 252 communicate via a communication link established via a supporting communication medium 255, e.g., a physical medium. According to the illustrative example, the supporting communication medium is free space, while the communication link is a wireless, RF communication link 253. It is understood that, without limitation, a base station may include a communication device, e.g., an eNB and/or a gNB, configured and/or operating according to one or more wireless communication technologies and/or protocols, such as those generally referred to as 4G, 4G/LTE, 5G New Radio and so on. Alternatively, or in addition, it is understood that the UE 252 may include any of the example wireless communications devices disclosed herein and/or otherwise generally known, such as mobile phones, smartwatches, tablet devices, laptop computers, and/or other smart devices, such as home appliances, security systems, home automation, home entertainment systems, vehicles, including self-driving vehicles and/or drones, commercial automation, robotic devices, and so on.

It is understood that, without limitation, the novel techniques disclosed herein may be applied to other communication systems and/or devices, such as RF devices, microwave devices, millimeter wave devices, terahertz devices, free-space optical devices, fiber optic communication devices, transmitters, receivers, transceivers, modems, repeaters, and so on. It is further understood that any of the example communication systems and/or devices may utilize the novel techniques disclosed herein for over similar and/or different communication mediums, such as free space, waveguide, including dielectric waveguide, optical fiber, coaxial cable, twisted copper pair, and so on. The communication links may include terrestrial radio links, free-space optical links, satellite communication links, broadband links, optical fiber links, coaxial cable links, twisted copper pair links, and so on.

According to the illustrative example, the base station 251 includes a transmitter subsystem 256 and a receiver subsystem 257 in communication with at least one antenna 254a. The transmitter subsystem 256 is configured to support communications over a downlink channel transmitting data via the antenna 254a from the base station 251 to the UE 252, while the receiver subsystem 257 is configured to support communications over an uplink channel receiving data via the antenna 254a from the UE 252. Likewise, the example UE 252 includes a transmitter subsystem 258 and a receiver subsystem 259 in communication with at least one antenna 254b. The transmitter subsystem 258 is configured to support communications over the uplink channel transmitting data via the antenna 254b from the UE 252 to the base station 251, while the receiver subsystem 259 is configured to support communications over an uplink channel receiving data via the antenna 254b from the base station 251.

It is envisioned that one or both of the transmitter subsystems 256, 258 may include a digital communication system configured to implement a spectrum coding scheme that facilitates compliance with OOB requirements, as may be defined by the applicable standards, e.g., 3GPP communication standards, with little to no pulse shaping and with low-resolution DACs, possibly down to single bit DACs. According to the illustrative embodiment, the base station 251 includes a modulation and code scheme (MCS) module 260 that is configured to identify one or more of a spectrum code, quantization and/or modulation scheme. In more detail, the MCS module 260 is in communication with the receiver subsystem 257 and configured to obtain an indication of a channel state or condition as might be reported by the UE 252 in an uplink message to the base station 251. By way of example, the receiver subsystem 257 receives an uplink message from the UE 252 that provides an indication of a channel state of a downlink in the form of a channel quality indicator (CQI) determined by the receiver module 259 the UE 252. According to the illustrative example, the base station 251 determines the channel state of the downlink via a reported CQI. Namely, the receiver subsystem 257, having received the CQI from the UE 252, provides the MCS module 260 with an indication of the channel condition associated with the downlink portion of the communication link 253. Without limitation, an indication of a channel state or condition may include one or more of a signal-to-noise ratio (SNR), a bit error rate (BER), a channel quality indicator (CQI), and so on. According to the illustrative example, the MCS module 260 receives an indication of a CQI of a downlink portion of the link 253.

According to the illustrative example, channel state information (CSI) may be determined according to a codebook-based technique, in which the base station transmitter subsystem 256 sends downlink (DL) reference signals. The UE receiver subsystem 259 receives the DL reference signals, applies processing to obtain CSI, which it sends to the UE transmitter subsystem 258 in the form of UE-reported CQI. The base station receiver subsystem 257 receives the UE-reported CQI and sends it to the MCS Module 260, e.g., to be used in determining an MCS. Alternatively, or in addition, the base station 251 may obtain CSI using other techniques, including techniques in which the CSI is obtained using processing based within the base station. Whereas the example CQI technique may be standardized, e.g., being exchanged between the UE and BS, other channel state techniques are not limited to standards and may include proprietary implementations. By way of nonlimiting example, the UE transmitter subsystem 258 sends signals, e.g., sounding reference signals (SRS), which the base station receiver subsystem 257 receives and processes to obtain CSI, which may be provided to the MCS Module 260.

Alternatively, or in addition, the MCS module 260 may obtain an indication of an OOB constraint 261. The indication of the OOB constraint 261 may be obtained by reference, e.g., according to an applicable standard. Alternatively, or in addition the indication of the OOB constraint 261 may be encoded within the operational functionality of the MCS module 260, and/or provided as user input, and/or obtained from an estimate of other conditions, such as channel spacing, noise, interference, signal levels, receiver sensitivities, filters. In at least some embodiments, the OOB constraint 261 is obtained by reference to an applicable standard, which may refer to the OOB constraint as a maximum allowable percentage of total transmitted signal energy, q outside of a channel bandwidth. The MCS module 260 may identify a strategy adapted to facilitate transmitter operation compliant with the OOB constraint 261. For example, the strategy, e.g., the MCS, may identify one or more of a type of spectrum code and a spectrum code rate. Alternatively, or in addition, the MCS module 260 may identify one or more configuration parameters based on the channel condition, e.g., the CQI, and the OOB constraint. By way of nonlimiting example, the configuration parameters may include one or more of a symbol rate and/or quantization and/or a channel code type, and/or a channel code rate.

In at least some embodiments, the MCS module 260 is adapted to obtain one or more other factors 269 in addition to the example channel condition indicated by the CQI. By way of nonlimiting example, the other factors 269 may include an indication of interference as may result from multi-user transmission. It is understood that, without limitation, the other factors 269 may be based at least in part on measurements, estimates, configuration data, historical records, and so on. Accordingly, the MCS module 260 may consider channel conditions fed back from the UE 252 alone or in combination with the other factors 269, such as interference, to obtain an adjusted channel condition suitable for encoding downlink data directed towards the base station 251.

The MCS module 260 may identify a bandwidth-related power constraint, e.g., an OOB constraint, including at least one of a channel bandwidth (B) and fractional out-of-band power (η). The MCS module 260 may determining a symbol rate (β*), and MCS information, e.g., an MCS level, which may include a spectrum coding scheme (SC), a spectrum code rate (r₁*), and a channel coding rate (r₂*), based on the channel condition and the bandwidth-related power constraint. The transmitter module 260 may, in turn, inform the UE 272 of the determined parameters, such that the receiver subsystem 259 may decode the data to obtain a reliable estimation of the transmitted data.

The MCS module 260 may provide MCS information, such as a selected spectrum code type and rate, and perhaps a symbol rate and/or quantization and provides that to the transmitter module 256, such that the transmitted downlink data may be configured for compliance with the OOB constraint. Alternatively, or in addition, the transmitter module 256 may forward the MCS information to the UE 252. The receiver module 259 of the UE 252 may extract the MCS information and forward it to the MCS controller module 262, which, in turn, may adjust operations of the receiver subsystem 259 according to the MCS information to facilitate a decoding of the MCS encoded information at the receiver subsystem 259.

In at least some embodiments, the MCS module 260 determines MCS information according to reference data. The reference data may include tabular data, e.g., indicating associations of channel conditions and OOB constraints with MCS information and/or symbol rate and/or quantization data. Alternatively, or in addition, the MCS information may be obtained from an algorithm adapted to provide MCS information based on input values, e.g., OOB constraint. Tabulated results may be stored locally, e.g., in a storage location within the base station 251. Alternatively, or in addition, the associations, e.g., tabular data may be stored remotely to the base station 251. An example storage system 265 may include tabular MCS association data 267 that may be accessed by the MCS selector module 260, e.g., via network communications. The storage system 265 may include a database and/or other MCS information resource that may be determined and/or otherwise updated and/or maintained.

It is envisioned that in at least some embodiments, the UE 252 may obtain information from elsewhere than downlink information provided by the base station 251. For example, the UE 252 may obtain MCS information from an MCS selector 264 not included within the base station 251. For example, the MCS selector 264 may be resident within the UE 252 and/or at some other network accessible location, e.g., at a remote or centralized location. The MCS selector 264 may identify an OOB constraint and/or an estimate of channel conditions and/or other data as may facilitate identification of MCS information configured to satisfy OOB constraints imposed on the transmitter module 256 of the base station 251. The MCS selector 264 may access MCS association data, such as the example tabular MCS association data 267, such that the MCS selector 264 may determine the information based on the OOB constraint and the channel condition in view of the MCS association data 267.

It is further envisioned that, in at least some embodiments, machine learning may be applied to any one or more of the techniques disclosed herein. For example, an artificial intelligence (AI) module 266 may be configured to facilitate generation of the MCS association data, to identify channel conditions, such as CQI and/or other factors, and/or to obtain the MCS information. In at least some embodiments, the AI module 266 may incorporate a neural network, e.g., a deep neural network that may be trained on training data 268 and operated to determine information relevant to identification of the MCS information. It is understood that in at least some embodiments, one or more of the MCS selector 264, the storage system 265, the AI module 266, the tabular MCS association data 267, the training data 268, if present, may reside, in whole or in part, within and/or proximate to the base station 251.

FIG. 2G is a block diagram illustrating an example, non-limiting embodiment of an example operation of a digital communication system 270 adapted for managing OOB emissions through spectral coding with low-resolution DACs, functioning within the communication network of FIG. 1 in accordance with various aspects described herein. The digital communication system includes a transmitter system 271, e.g., a transmitter module 256 of the base station 251 (FIG. 2F) adapted for communicating wirelessly with a receiver system 272, e.g., a receiver module 259 of the UE 252.

The receiver system 272 obtains an estimate of a channel condition of a downlink communication channel between the transmitter system 271 and the receiver system 272. The estimate of the downlink channel condition may be obtained by any suitable technique adapted to measure, estimate and/or otherwise characterize a condition of a communication channel. According to the illustrative example, the receiver system 272 generates a CQI value at 273 representative of the estimated downlink channel condition and provides the CQI value to the transmitter system 271 via an uplink communication channel, e.g., within uplink control information 274 portion of an uplink communication.

The transmitter system 271 determines spectral encoding scheme based at least in part on an OOB constraint and the CQI value. In at least some embodiments, the spectral encoding scheme includes an indication of a type of spectral coding, e.g., polar coding and/or the example variant. The indication may also include a corresponding coding rate of the polar code. The transmitter system 271 may encode the spectral encoding scheme, e.g., as MCS information, at 274 into a downlink message to the receiver system 272, e.g., within a downlink control information (DCI) information 275 portion of a downlink communication.

The receiver system 272 receives the downlink communication, accesses the DCI information 275 provided therein and decodes it at 276 to obtain the MCS information. The receiver system 272 may reconfigure one or more receiver attributes according to the MCS information, e.g., adjusting a spectrum decoder module according to the MCS information. Attributes may include, without limitation, one or more of spectrum encoding/decoding type, spectrum encoding/decoding rate, a modulation type, a symbol rate, a channel coding type and/or a channel encoding rate. The spectrum decoder may be operated to effectively retrieve and/or otherwise obtain a reliable representation of the digital information provided by the transmitter system 271.

The transmitter system 271, having informed the receiver system 272 of the MCS information, may proceed to encode subsequent downlink communications according to the MCS information to obtain MCS encoded data. The MCS encoded data may be transmitted to the receiver system 272 via the downlink communication channel. The receiver system 272 receives the MCS encoded data and decodes it according to the MCS information at 279. Thus, the OOB performance may be assured as compliant with the OOB constraint based on configuration and transmission according to the MCS information.

An example first MCS association is provided in Table 1, provided below. The example MCS association includes an Input portion and an output portion. The input portion includes a channel estimate in the form of an estimated SNR. The input may also identify a target spectral efficiency, measured in bit/s/Hz, and an OOB constraint. The example OOB constraint refers to a percentage of total spectral emissions permitted outside of an allocated channel bandwidth. The output portion includes a symbol rate and what is referred to as an MCS level. The MCS level identifies a type of spectrum encoding, e.g., polar or the example variant, as well as a spectral encoding rate. The spectral encoding rate indicates a ratio of information bits (or channel bits) to be transmitted.

TABLE 1
First MCS Associations.

| INPUT: | | | Output: | |
|---|---|---|---|---|
| | | OOB | Symbol | |
| SNR | Target SE | constraint | rate | |
| (dB) | (bits/s/Hz) | (%) | (×B) | MCS |
| 13 | 0.1 | 1 | 0.2 | Variant (1/2) |
| 13 | 0.5 | 1 | 16 | Polar (1/16) |
| 13 | 1 | 1 | 38 | Polar (1/38) |
| 13 | 0.5 | 5 | 1 | Variant (1/2) |
| 13 | 1 | 5 | 9 | Polar (1/9) |

Accordingly, under a given channel condition, i.e., SNR, and OOB constraints, the first MCS associations in Table 1 indicate corresponding symbol rate and MCS to meet the identified target SE. According to the MCS association tables, the MCS level and symbol rates may be jointly determined. Here, the symbol rate is a multiple of the channel bandwidth (denoted by B), and the MCS consists of two parts: a code scheme (polar code or the “variant”) and a code rate (e.g., 1/9).

Identifying the bandwidth-related power constraint, including at least one of a channel bandwidth (B) and fractional out-of-band power (η). Determining the symbol rate (β*), the MCS level (including the spectrum coding scheme (SC), the spectrum code rate (r₁*), and the channel coding rate (r₂*)), based on the channel condition and the bandwidth-related power constraint. An MCS module, such as may be in communication with a transmitter for which the OOB constraints are to be satisfied, may inform the receiver of the determined parameters.

In at least some embodiments, implementation of a spectrum encoding scheme to ensure OOB constraints are met may utilize a multistep process. By way of example, implementation of a spectrum encoding scheme includes a two-step process. According to a first step, an OOB constraint (η) as may be determined according to a frequency spectrum allocation, a frequency license, a communication standards, or the like. A symbol rate (β*), and a spectrum coding scheme, e.g., including a type of spectrum code (SC) and a corresponding code rate (r₁*), may be determined based on the OOB constraint. In at least some embodiments, a determination of the symbol rate and spectrum encoding scheme may be accomplished according to a second step and/or by referring to a look-up table of the associations.

Another example MCS association is provided in Table 2, provided below. The example MCS association also includes an input portion and an output portion. The input portion includes a channel estimate in the form of CQI value and identification of an OOB constraint. The output portion includes a symbol rate (β*), a type of spectrum encoding (SC) and a spectral encoding rate (r₁*). The value β* refers to a symbol rate normalized by an allocated, e.g., a channel, bandwidth B. In at least some embodiments, the output may also include a channel code rate r₂*

Accordingly, under a given channel condition, i.e., CQI, and OOB constraints, the MCS associations in Table 2, indicate corresponding symbol rate, spectral code type, spectral code rate and channel code rate to meet the identified OOB constraint. According to the MCS association tables, the spectral code type, symbol rates and code rates may be jointly determined.

TABLE 2
Second MCS Association.

| INPUT: | | Output: | | | |
|---|---|---|---|---|---|
| Channel | OOB | Symbol | | Spectrum | Channel |
| Quality | Constraint | rate | Spectrum | Code | Code |
| Indicator | (%) | (×B) | Code | Rate | Rate |
| CQI | η | β* | SC | r₁* | r₂* |

In at least some embodiments, the determination can be accomplished by looking up in a table, such example MCS associations included in Table 3, provided below.

TABLE 3
Example MCS Associations.

| | | Output: | | | |
|---|---|---|---|---|---|
| INPUT: | | | | Spectrum | Channel |
| Channel | OOB | Symbol | Spectrum | Code | Code |
| Quality | Constraint | rate (β*) | Code | Rate | Rate |
| Indicator | (%) | (×B) | (SC) | (r₁*) | (r₂*) |
| 10 | 1 | 0.2 | Variant | 1/2 | 1/2 |
| 15 | 1 | 0.2 | Variant | 1/2 | 7/8 |
| 15 | 5 | 9 | Polar | 1/9 | 7/8 |

Continuing with the example two-step process, a first step may be performed by looking up, for a given OOB constraint, a corresponding values of symbol rate, spectrum code type and/or spectrum code rate as may be provided in a predetermined spectrum coding table, such as the example spectrum coding associations included in Table 4, provided below.

TABLE 4
Spectrum Coding Associations.

Output:

| Input | | | Spectrum |
|---|---|---|---|
| OOB | Symbol | Spectrum | Code |
| Constraint | rate (β) | Code | Rate |
| (%) | (×B) | (SC) | (r₁*) |
| η | β* | SC | r₁* |

An input value may be based on an OOB constraint, such as the value η, which represents a limit on a ratio between the transmitted power out of the allocated band and the total transmit power. Output values may include a symbol rate β* normalized by the allocated bandwidth B. Another output value may include, without limitation, a spectrum code (SC) used to reduce, limit and/or otherwise confine OOB emissions. Another output value may include, without limitation, a code rate, r₁*, as may be used to the SC.

It is understood that in at least some embodiments, at least some of the entries of Table 4, e.g., an example spectrum coding table may be obtained by a systematic application of one or more relationships. By way of nonlimiting example, a particular code scheme is identified for investigation. An application of the identified code scheme results an encoded signal having a corresponding power spectral density, which may be represented as a function of symbol rate, β, and code rate, r₁, i.e., Sₓ(f; β, r₁). Additionally, a constraint on emissions may also be identified. By way of nonlimiting example, an OOB value, q, representing an acceptable maximum percentage of signal power residing outside of an allocated bandwidth, B.

According to the illustrative example, for a given OOB value, η, and a relationship for the encoded signal's power spectral density as a function of frequency, based on a symbol rate, β, and a code rate, r₁, values of symbol rate, β, and code rate, r₁, may be solved for, such that the OOB constraint is satisfied. An example expression for power spectral density of a signal encoded according to a polar variant code is provided in Eq. 1, provided below:

$${S}_{x} ( f ; β , {r}_{1} ) = \frac{a}{1 - a} \frac{1 - {\vert \frac{a ( 1 - a )}{1 - ( 1 - a ) {e}^{j 2 π f} / β} \vert}^{2}}{{\vert 1 + \frac{a ( 1 - a ) {e}^{j 2 π f} / β}{1 - ( 1 - a ) {e}^{j 2 π f} / β} \vert}^{2}} {\vert \frac{1}{π f} \vert}^{2} β , where \qquad Eq . 1$$

$${r}_{1} = {h}_{2} ( a ) = - a {log}_{2} a - ( 1 - a ) {log}_{2} ( 1 - a )$$

Continuing with the illustrative example, an expression for the OOB constraint, η, provided below in Eq. 2, may be solved to obtain values for the symbol rate, β, and the code rate, r₁.

$$η = 1 - {\int }_{- 1 / 2}^{1 / 2} {S}_{x} ( f ; β , {r}_{1} ) df \qquad Eq . 2$$

Example Spectrum Coding Associations are tabulated in Table 5, provided below.

TABLE 5
Example Spectrum Coding Associations.

| | Output: | | |
|---|---|---|---|
| Input | | | Spectrum |
| OOB | Symbol | Spectrum | Code |
| Constraint | rate (β) | Code | Rate |
| (%) | (×B) | (SC) | (r₁*) |
| 1 | 0.2 | Variant | 1/2 |
| 1 | 16 | Polar | 1/16 |
| 1 | 38 | Polar | 1/38 |
| 5 | 1 | Variant | 1/1 |
| 5 | 9 | Polar | 1/9 |

According to Step 2, Input: CQI: channel quality indicator reported from the receiver. β*, r₁*: determined from step 1. Output: r₂* code rate used for channel coding.

How: Based on the CQI and (β*, r₁*) compute the spectral efficiency R by evaluating the mutual information under the constraint of spectrum coding. Select r₂*<R/β*.

Example results of step 2 are presented in Table 6, provided below.

TABLE 6
Example Results.

| Inputs: | | | | Output: |
|---|---|---|---|---|
| | | | Spectrum | Spectrum |
| | Symbol | Spectrum | Code | Code |
| | rate (β) | Code | Rate | Rate |
| CQI | (×B) | (SC) | (r₁*) | (r₁*) |
| 10 | 0.2 | Variant | 1/2 | 1/2 |
| 15 | 0.2 | Variant | 1/2 | 7/8 |
| 15 | 9 | Polar | 1/9 | 7/8 |

Based on the tabulated associations, a solution may be obtained using a polar code or its variant, whose processing steps are described in reference to FIGS. 2C and 2D. Referring again to FIGS. 2C and 2D, a difference between the two spectrum encoding schemes relates to a transformation after an application of polar encoding. Namely, a first application of the encoding illustrated in FIG. 2C refers to directly mapping the polar codewords, e.g., v=0 or 1, to possible symbols, e.g., BPSK, x=−1 or 1, by a linear transformation x=1-2 v. A second application of the encoding illustrated in FIG. 2D refers to another approach using a NRZI (Non-return-to-zero inverted) mapping.

For example, given an SNR=13 dB and an OOB constraint of 5%, and with a goal of satisfying an SE of about 1 bits/s/Hz, a symbol rate would need to be about 9 times a channel bandwidth, with the code scheme as the “variant” with code rate 1/9. Then, according to FIG. 2D, the information bits may be first polar-encoded with code rate 1/9, and then NRZI mapped to −1 or +1, and fed into a low-resolution DAC, e.g., a one-bit DAC, which may be operated at the determined symbol rate. According to this example, since the symbol is just one-bit, a one sample per symbol may be used as a symbol rate throughout.

FIG. 2H depicts an illustrative embodiment of a digital communication process 280 adapted for managing OOB emissions through spectral coding and with low-resolution DACs, in accordance with various aspects described herein. The example process 280 includes determining a channel condition, at 282. The channel condition may include an indication of one or more of an overall channel quality, e.g., according to a CQI. Alternatively, or in addition, the channel condition may include, without limitation, any combination of one or more of an SNR, an interference, a noise floor, a signal level, an error rate.

Further according to the example digital communication process 280, a bandwidth-related constraint is identified, at 284. The bandwidth-related constraint may include a limitation on spectral emissions of a transmitter engaging in transmission of digital information. In at least some embodiments, the bandwidth-related constraint may include an OOB emissions constraint. By way of example, an OOB emissions constraint may include a maximum permissible percentage of transmitted power spectral density that occurs outside of an allocated bandwidth, e.g., a channel bandwidth.

A spectrum encoding strategy may be determined, at 286, which may be based at least in part upon the bandwidth-related constraint, the channel condition, and/or a combination thereof. In at least some embodiments, the spectrum encoding strategy includes one or more of an identification of a spectrum code, a spectrum code rate, a symbol rate and/or a channel code rate. In at least some embodiments, the spectrum code is adapted to introduce relatively long strings of a common state in a transmitted signal, e.g., long strings of 0's and/or 1's. At least one class of codes adapted for this includes polar codes, including variants thereof.

In at least some embodiments, a spectrum encoding strategy, once identified, may be shared in whole or in part to a receiver, at 288. For example, the spectrum encoding strategy may be transmitted to a receiver device over the same channel identified by the channel condition. The receiver, in turn, may configure one or more receiver circuits and/or modules according to the spectrum encoding strategy, such that a suitably configured receiver may reliably receive digital information transmitted in accordance with the spectrum encoding strategy to ensure compliance with the bandwidth-related constraint.

While for purposes of simplicity of explanation, the digital communication process 280 shown and described as a series of blocks in FIG. 2H. It is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

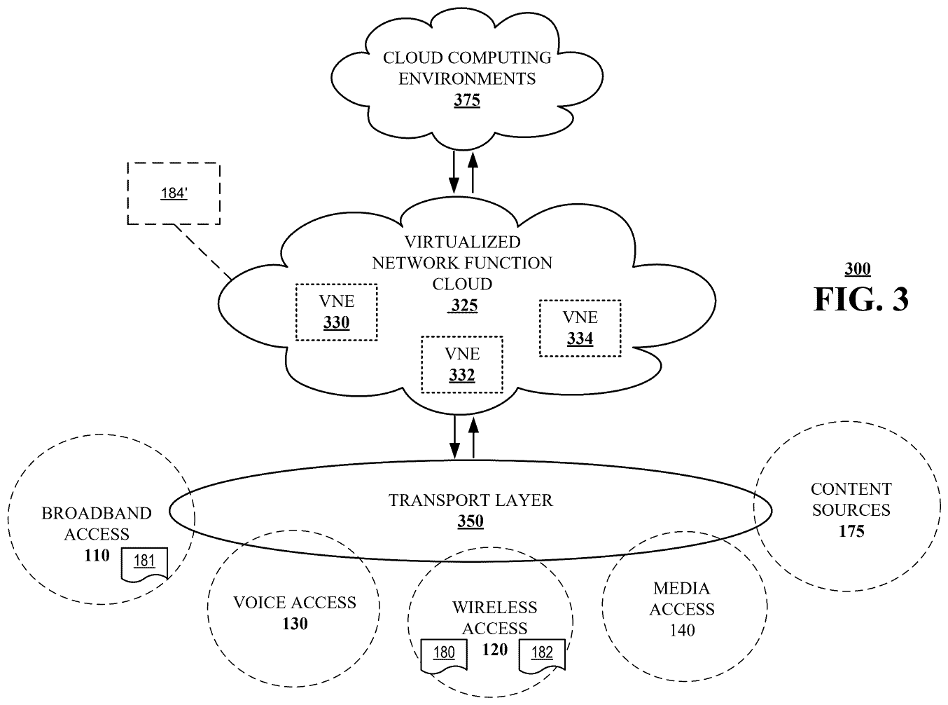

Referring now to FIG. 3, a block diagram is shown illustrating an example, non-limiting embodiment of a virtualized communication network 300 adapted for managing OOB emissions through spectral coding with low-resolution DACs in accordance with various aspects described herein. In particular a virtualized communication network is presented that can be used to implement some or all of the subsystems and functions of system 100, the subsystems and functions of systems 210, 220, 225, 230, 250, 270 and method 280 presented in FIGS. 1, 2B, 2C, 2D, 2E, 2F, 2G, 2H and 3. For example, virtualized communication network 300 can facilitate in whole or in part determination of a channel condition of a communication channel and identification of a bandwidth-related power constraint imposed upon the communication channel. A spectrum encoding strategy may be determined based on the channel condition and the bandwidth-related power constraint, wherein an application of the spectrum encoding strategy facilitates compliance with the bandwidth-related power constraint. The spectrum encoding strategy may be provided to a receiver to facilitate reliable communication of digital information over the communication channel according to the bandwidth-related power constraint.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc., to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc., can be instantiated and managed using an orchestration approach similar to those used in cloud compute services.

The cloud computing environments 375 can interface with the virtualized network function cloud 325 via APIs that expose functional capabilities of the VNEs 330, 332, 334, etc., to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

It is envisioned that in at least some of the VNEs 330, 332, 334 of the virtualized communication network 300 may be configured to apply spectrum encoding techniques, such as any of the various examples provide herein, to address OOB emissions at least in part, based on an application of spectrum coding, such as the example polar encoding techniques discussed herein. In at least some embodiments the spectrum codes may be identified and/or otherwise selected for application based on an OOB specified value, such as maximum percentage of tolerable OOB emissions.

It is envisioned that digital transceivers 180a, 180b, 181 of one or more of the example communication subsystems, e.g., the broadband access 110 and/or the wireless access 120, may be configured to identify a channel condition and an OOB requirement, to select a modulation and/or encoding scheme that applies a spectrum code, such as a polar code to satisfy, at least in part, the OOB requirements.

In at least some embodiments, the digital transceivers 180a, 180b, 181 may be adapted to identify suitable modulation and coding schemes based on channel conditions and OOB emission requirements. Alternatively, or in addition, a remote processor 184′, which may be implemented at least in part on a virtualized machine, may be configured to identify channel conditions and applicable OOB emission requirements, and to select a suitable digital radio configuration, e.g., an MCS, adapted to satisfy the OOB conditions in view of the channel conditions. Such MCS solutions may be provided by the processor 184 to the corresponding digital radios 180a, 180b, 181, which may be configured to reconfigure based on the received MCS configuration.

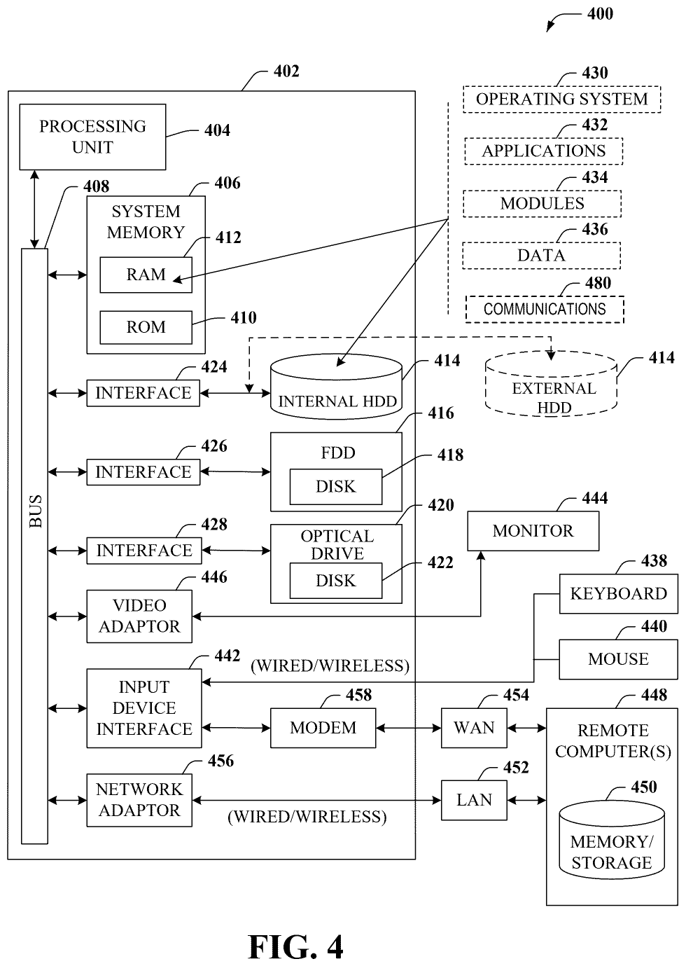

Turning now to FIG. 4, there is illustrated a block diagram of an example, non-limiting embodiment of a computing environment adapted for managing OOB emissions through spectral coding with low-resolution DACs in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. In at least some embodiments, the access point 122 may be configured to identify a channel condition and an OOB requirement, to select a modulation and/or encoding scheme that applies a spectrum code, such as a polar code to satisfy, at least in part, the OOB requirements. Each of these devices can be implemented via computer-executable instructions that can run on one or more computers, and/or in combination with other program modules and/or as a combination of hardware and software. For example, computing environment 400 can facilitate in whole or in part determination of a channel condition of a communication channel and identification of a bandwidth-related power constraint imposed upon the communication channel. A spectrum encoding strategy may be determined based on the channel condition and the bandwidth-related power constraint, wherein an application of the spectrum encoding strategy facilitates compliance with the bandwidth-related power constraint. The spectrum encoding strategy may be provided to a receiver to facilitate reliable communication of digital information over the communication channel according to the bandwidth-related power constraint.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

It is envisioned that in at least some of the modules may be include a communications module 480 configured to apply and/or otherwise support application of spectrum encoding techniques, such as any of the various examples provide herein, to address OOB emissions at least in part, based on an application of spectrum coding, such as the example polar encoding techniques discussed herein. In at least some embodiments the spectrum codes may be identified and/or otherwise selected for application based on an OOB specified value, such as maximum percentage of tolerable OOB emissions.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen and the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

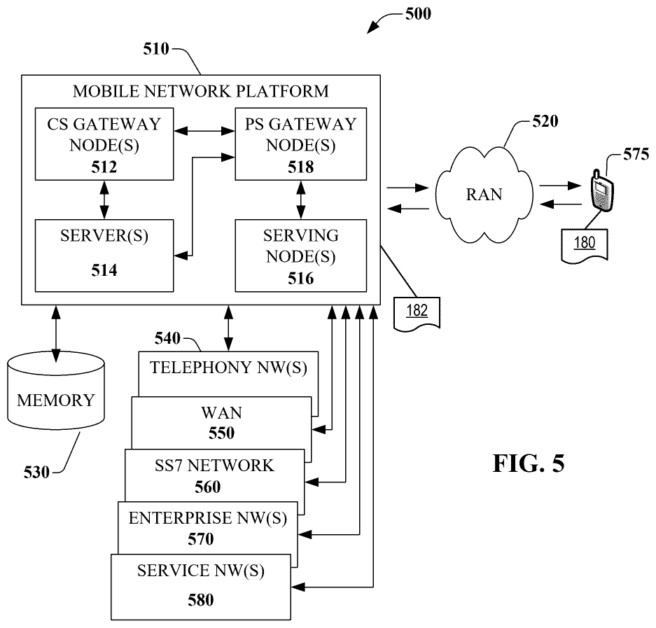

Turning now to FIG. 5, block diagram of an example, non-limiting embodiment 500 of a mobile network platform 510 adapted for managing OOB emissions through spectral coding with low-resolution DACs in accordance with various aspects described herein is shown that is an example of network elements 150, 152, 154, 156, and/or VNEs 330, 332, 334, etc. For example, platform 510 can facilitate in whole or in part determination of a channel condition of a communication channel and identification of a bandwidth-related power constraint imposed upon the communication channel. A spectrum encoding strategy may be determined based on the channel condition and the bandwidth-related power constraint, wherein an application of the spectrum encoding strategy facilitates compliance with the bandwidth-related power constraint. The spectrum encoding strategy may be provided to a receiver to facilitate reliable communication of digital information over the communication channel according to the bandwidth-related power constraint. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc., that perform particular tasks and/or implement particular abstract data types.

It is envisioned that in at least some embodiments, the mobile network platform 510 alone and/or in combination with the UE 575 may be configured to apply spectrum encoding techniques, such as any of the various examples provide herein, to address OOB emissions at least in part, based on an application of spectrum coding, such as the example polar encoding techniques discussed herein. In at least some embodiments the spectrum codes may be identified and/or otherwise selected for application based on an OOB specified value, such as maximum percentage of tolerable OOB emissions.

It is envisioned that digital transceivers 180, 181 of mobile network platform 510 alone and/or in combination with the UE 575, may be configured to identify a channel condition and an OOB requirement, to select a modulation and/or encoding scheme that applies a spectrum code, such as a polar code to satisfy, at least in part, the GOB requirements.

In at least some embodiments, the digital transceivers 180, 181 may be adapted to identify suitable modulation and coding schemes based on channel conditions and OOB emission requirements. In at least some embodiments, these techniques may be performed at least in part with the support of a remote processor 184, 184′ (FIGS. 1 and 3, which may be implemented at least in part on a virtualized machine, may be configured to identify channel conditions and applicable OOB emission requirements, and to select a suitable digital radio configuration, e.g., an MCS, adapted to satisfy the OOB conditions in view of the channel conditions. Such MCS solutions may be provided by the processor remote 184, 184′ to the corresponding digital transceivers 180, 181, which may be configured to reconfigure based on the received MCS configuration.

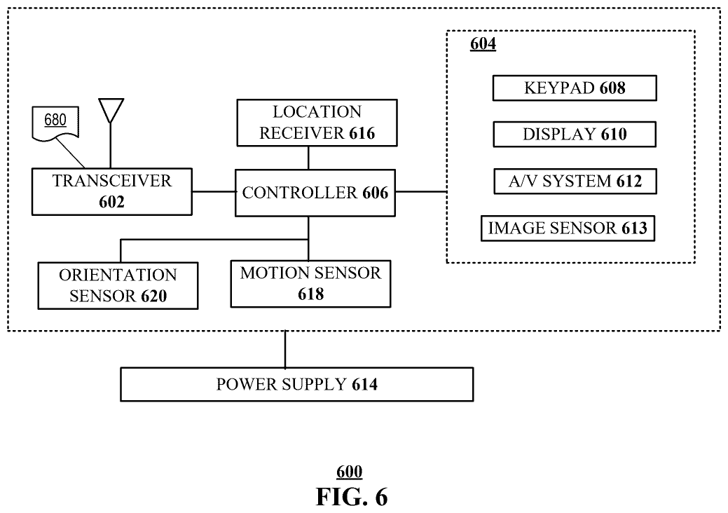

Turning now to FIG. 6, a block diagram of an example, non-limiting embodiment of a communication device 600 is shown. The communication device 600 is adapted for managing OOB emissions through spectral coding with low-resolution DACs in accordance with various aspects described herein. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part determination of a channel condition of a communication channel and identification of a bandwidth-related power constraint imposed upon the communication channel. A spectrum encoding strategy may be determined based on the channel condition and the bandwidth-related power constraint, wherein an application of the spectrum encoding strategy facilitates compliance with the bandwidth-related power constraint. The spectrum encoding strategy may be provided to a receiver to facilitate reliable communication of digital information over the communication channel according to the bandwidth-related power constraint.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

It is envisioned that in at least some embodiments, the transceiver 602 may include OOB management functionality 680 configured to apply spectrum encoding techniques, such as any of the various examples provide herein, to address OOB emissions at least in part, based on an application of spectrum coding, such as the example polar encoding techniques discussed herein. In at least some embodiments the spectrum codes may be identified and/or otherwise selected for application based on an OOB specified value, such as maximum percentage of tolerable OOB emissions.

It is envisioned that the OOB functionality 680 may be configured to identify a channel condition and an OOB requirement, to select a modulation and/or encoding scheme that applies a spectrum code, such as a polar code to satisfy, at least in part, the OOB requirements.

Although the various techniques disclosed herein are well suited for managing, limiting and/or otherwise reducing OOB emissions within single carrier communications, it is envisioned that, in at least some embodiments, they may be applied to multicarrier communications.

In at least some embodiments, the OOB functionality 680 may be adapted to identify suitable modulation and coding schemes based on channel conditions and OOB emission requirements. In at least some embodiments, these techniques may be performed at least in part with the support of a remote processor 184, 184′ (FIGS. 1 and 3, which may be implemented at least in part on a virtualized machine, may be configured to identify channel conditions and applicable OOB emission requirements, and to select a suitable digital radio configuration, e.g., an MCS, adapted to satisfy the GOB conditions in view of the channel conditions. Such MCS solutions may be provided by the processor remote 184, 184′ to the GOB functionality 680, which may be configured to reconfigure based on the received MCS configuration.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, for determining a coding strategy to promote confinement of power spectral density within an allocated bandwidth, the method comprising:
determining, by a processing system including a processor, channel condition of a communication channel;
identifying, by the processing system, a bandwidth-related power constraint imposed upon the communication channel to control out-of-band emissions;
determining, by the processing system, a spectrum encoding strategy based on the channel condition and the bandwidth-related power constraint, wherein application of the spectrum encoding strategy to digital information yields spectrum-encoded data configured to facilitate compliance of a transmission of the encoded data with the bandwidth-related power constraint; and
transmitting, by the processing system, the spectrum encoding strategy to a receiver to facilitate reliable communication of the digital information over the communication channel according to the bandwidth-related power constraint.

2. The method of claim 1, wherein the identifying further includes:
identifying, by the processing system, a channel bandwidth, wherein the spectrum encoding strategy is determined at least in part according to the channel bandwidth.

3. The method of claim 2, wherein channel bandwidth is identified according to a data rate for communication of the digital information.

4. The method of claim 1, wherein the bandwidth-related power constraint comprises at least one of a bandwidth and a maximum permissible fractional out-of-band power.

5. The method of claim 1, wherein the determining the spectrum encoding strategy further comprises:
determining, by the processing system, a symbol rate and a modulation and coding scheme (MCS) according to the bandwidth-related power constraint and the channel condition, wherein the spectrum encoding strategy further comprises specification of the MCS.

6. The method of claim 5, wherein determining the symbol rate and the MCS further comprises:
selecting, by the processing system, the symbol rate and the MCS from among a plurality of tabulated associations of symbol rates and MCS adapted to ensure compliance with the bandwidth-related power constraint in view of the channel condition.

7. The method of claim 5, wherein the MCS comprises one of binary phase-shift keying (BPSK), on-off keying (OOK), and quadrature phase-shift keying (QPSK).

8. The method of claim 1, wherein the spectrum encoding strategy comprises:
applying, by the processing system, a polar code to the digital information to obtain polar encoded data.

9. The method of claim 8, wherein the spectrum encoding strategy further comprises:
applying, by the processing system, a non-return-to-zero inverted (NRZI) code to the polar encoded data to obtain variant encoded data.

10. The method of claim 1, wherein the channel condition includes at least one of a signal to noise ratio (SNR), a location of a communication terminal configured to engage in communication of the encoded data, and a velocity of the communication terminal.

11. The method of claim 1, further comprising determining, by the processing system, a symbol rate, wherein determining the spectrum encoding strategy further based on the symbol rate.

12. A device, comprising:
a processing system including a processor; and
a memory that stores executable instructions that, when executed by the processing system, facilitate performance of operations, the operations comprising:
receiving an indication of a channel condition of a communication channel;
identifying a bandwidth-related power constraint imposed upon the communication channel;
determining a spectrum encoding strategy based on the channel condition and the bandwidth-related power constraint, wherein application of the spectrum encoding strategy to digital information to obtain spectrum-encoded data facilitates compliance with the bandwidth-related power constraint; and
providing the spectrum encoding strategy to a receiver to facilitate reliable communication of the digital information over the communication channel according to the bandwidth-related power constraint.

13. The device of claim 12, wherein the determining the spectrum encoding strategy further comprises:
determining a symbol rate and a modulation and coding scheme (MCS) according to the bandwidth-related power constraint and the channel condition, wherein the spectrum encoding strategy further comprises specification of the symbol rate and the MCS.

14. The device of claim 13, wherein the determining the symbol rate and the MCS further comprises:
selecting the symbol rate and the MCS from among a predetermined number of symbol rates and MCS within tabulated associations adapted to ensure compliance with the bandwidth-related power constraint in view of the channel condition.

15. The device of claim 12, wherein the operations further comprise:
identifying a channel bandwidth, wherein the spectrum encoding strategy is determined at least in part according to the channel bandwidth.

16. The device of claim 15, wherein channel bandwidth is identified according to a required data rate for communication of the digital information.

17. The device of claim 12, wherein the operations further comprise:
applying a polar code to the digital information to obtain polar encoded data.

18. A non-transitory machine-readable medium, comprising executable instructions that, when executed by a processing system including a processor, facilitate performance of operations, the operations comprising:
determining channel condition of a communication channel;
identifying a bandwidth-related power constraint imposed upon the communication channel; and
determining a spectrum encoding strategy based on the channel condition and the bandwidth-related power constraint, wherein application of the spectrum encoding strategy to digital information to obtain encoded data facilitates compliance of a transmission of the encoded data with the bandwidth-related power constraint, and wherein configuration of receiver according to the spectrum encoding strategy facilitates reliable communication of digital information over the communication channel according to the bandwidth-related power constraint.

19. The non-transitory machine-readable medium of claim 18, wherein the operations further comprise:
identifying a modulation scheme for modulating the encoded data.

20. The non-transitory machine-readable medium of claim 18, wherein the operations further comprise:
applying a polar code to the digital information to obtain polar encoded data.
